(19) United States
(12) Patent Application Publication
(10) Pub. No.: US 2012/0264855 A1
(43) Pub. Date: Oct. 18, 2012

(54) CELLULOSE ESTER FILM, POLARIZING PLATE AND LIQUID CRYSTAL DISPLAY DEVICE

(75) Inventors: Yoshiaki HISAKADO, Kanagawa (JP); Ryo SUZUKI, Kanagawa (JP)

(73) Assignee: FUJIFILM CORPORATION, Tokyo (JP)

(21) Appl. No.: 13/448,141

(22) Filed: Apr. 16, 2012

(30) Foreign Application Priority Data
Apr. 18, 2011 (JP) 2011-092428

(51) Int. Cl. C08L 1/10

(52) U.S. Cl. 524/37

(57) ABSTRACT

A cellulose ester film includes: a cellulose ester and at least one polyester, in which a number average molecular weight of the polyester is 2,500 or less and a ratio of components having a molecular weight of 500 or less in the polyester is less than 8%.

This application is based on and claims priority under 35 U.S.C. §119 from Japanese Patent Application No. 2011-092428 filed Apr. 18, 2011, the entire disclosure of which is herein incorporated by reference.

### BACKGROUND OF THE INVENTION

### 1. Field of the Invention

The present invention relates to a cellulose ester film which can prevent the occurrence of optical nonuniformity of a liquid crystal display device can be prevented, and a polarizing plate and a liquid crystal display device using the cellulose ester film.

Films of polymers typified by cellulose esters, polyesters, polycarbonates, cycloolefin polymer, vinyl polymers, polyimides, and the like are used in silver halide photographic light-sensitive materials, retardation films (phase difference films), polarizing plates, and image display devices. From these polymers, films which are excellent in flatness and uniformity can be prepared, and thus are widely employed as films in optical applications.

Among these them, it is possible for a cellulose ester film having an appropriate moisture vapor permeability to be online directly attached to a polarizer including polyvinyl alcohol (PVA)/iodine, which is most commonly used. Therefore, in particular, a cellulose acetate film is widely employed as a protective film of a polarizing plate.

When these films are used in optical applications such as a retardation film, a support of a retardation film, a protective film of a polarizing plate, and a liquid crystal display device, controlling the optical anisotropy is a very important factor in determining the display device performance (for example, visibility). With the recent demand for enhancing the viewing angle of liquid crystal display devices, improvement of retardation compensation has been desired, and the retardation value in an in-plane direction (Re; hereinafter, may be simply referred to as “Re”) and the retardation value in a thickness direction (Rth; hereinafter, may be simply referred to as “Rth”), of a retardation film disposed between a polarizer and a liquid crystal cell, are required to be appropriately controlled. For example, in liquid crystal display devices in an in plane switching (IPS) mode, which are widely used in liquid crystal TV sets, both Re and Rth are required to be reduced, and thus, for example Patent Document 1 (Japanese Patent Application Laid-Open No. 2007-178992) discloses a technology which allows a polyester compound including divalent alcohol and dibasic acid to be contained in a cellulose acylate.

As for the control by such an additive, a technology regarding a cellulose ester film, which contains polyester having a weight average molecular weight of 20,000 or less, is disclosed in Patent Document 2 (WO 07/000910 A corresponding to US 2007/0048462 A1).

Recently, as a liquid crystal display device becomes thinner, it has been found out that a circular optical nonuniformity occurs when the display surface is observed from the front side under a specific condition. While the mechanism of the occurrence of such optical nonuniformity has not altogether been clarified, one of the causes is a contact between a backlight member and a liquid crystal panel (particularly, the polarizing plate on the backlight side). Therefore, Patent Document 3 (Japanese Patent Application Laid-Open No. 2009-169393) discloses a method for inhibiting the occurrence of optical nonuniformity by providing surface asperity on the surface of the backlight side protective film of a polarizing plate on the backlight side so as to prevent a contact with a backlight member.

### SUMMARY OF THE INVENTION

However, in the technology in Patent Document 3, surface asperity is provided, and thus, incident light scatters to reduce utilization efficiency. Therefore, it is required that measures may be sufficiently taken against the occurrence of optical nonuniformity such that a change in asperity is not imparted to on the surface shape.

Thus, the present inventors have studied to provide a cellulose ester film and a polarizing plate, which can prevent a circular optical nonuniformity from occurring on the display surface when the cellulose film and the polarizing plate are applied to a liquid crystal display device, as an object of the present invention. It has also been turned out that the problem of optical nonuniformity can be solved by using, as a cellulose ester film, a cellulose ester film in which humidity dependence of Rth is reduced by containing a specific polyester as an additive.

However, if such a film continue to be manufactured, new problems appears in that a change in optical or mechanical performance due to volatile components of the additive occurs (for example, deterioration of the film surface shape) when the amount of the additive added is increased.

Therefore, it is an object of the present invention to provide a cellulose ester film which can prevent the occurrence of optical nonuniformity on the display surface when applied to a liquid crystal display device and has an excellent film surface shape, a polarizing plate and a liquid crystal display device using the cellulose ester film.

The present inventors have conducted intensive studies to solve the above-mentioned problems, and as a result, have found that the problem associated with the volatilization of additives results from the volatilization of low-molecular weight components of the additive. That is, with a measure including additives, an effect that the additives should exhibit is reduced due to the volatilization of low-molecular weight components, and thus, a desired effect may not be stably obtained. Therefore, it has been turned out that it is preferable to prevent volatilization of the additives by controlling the molecular weight distribution of the additives and that a film having a desired performance may be manufactured by the control of the molecular weight. It has also been turned out that, by adding polyester having a specific molecular weight distribution, a change in performance due to volatilization may be prevented while the humidity dependence of Rth is reduced and the occurrence of optical nonuniformity is inhibited, thereby achieving the present invention.

Although Patent Document 2 describes that polyester having a wide molecular weight distribution to the low-molecular weight side is compatible with cellulose ester, there is no mention regarding the volatilization of low-molecular weight components. Therefore, according to the Patent Document 2, there is a possibility that contamination of a manufacturing process or breakdown in the film shape may be caused by volatilization of low-molecular weight component, and the result thereof is not satisfactory from the viewpoint of manufacturability.

The above-mentioned object of the present invention can be accomplished by the following means.

[1]

A cellulose ester film including: a cellulose ester and at least one polyester, wherein a number average molecular weight of the polyester is 2,500 or less and a ratio of components having a molecular weight of 500 or less in the polyester is less than 8%.

The cellulose ester film described in [1], wherein the polyester is a polycondensed ester of an aliphatic dicarboxylic acid and an aliphatic diol.

[3]

The cellulose ester film described in [2], wherein both terminals of the polyester are an ester derivative of an aliphatic monocarboxylic acid.

The cellulose ester film described in [2] or [3], wherein the aliphatic diol has an average carbon number of 2 to 3.

[5]

The cellulose ester film described in any one of [2] to [4], wherein the aliphatic dicarboxylic acid has an average carbon number of 4 to 6.

[6]

The cellulose ester film described in any one of [1] to [5], wherein an amount of the polyester is 30% by mass or more based on the cellulose ester.

[7]

The cellulose ester film described in any one of [1] to [6], further including at least one nitrogen-containing aromatic compound.

[8]

The cellulose ester film described in any one of [1] to [7], wherein the cellulose ester film has an in-plane retardation Re of 0 to 5 nm and a retardation Rth in a thickness direction of −20 to 10 nm, at 25° C. and 60% RH, and

a difference between a retardation Rth (10% RH) in the thickness direction at 25° C. and 10% RH and a retardation Rth (80% RH) in the thickness direction at 25° C. and 80% RH satisfies the following equation:

Rth(10% RH)−Rth(80% RH)<8 nm.

[9]

The cellulose ester film described in any one of [1] to [8], wherein a weight reduction rate of a film when kept at 140° C. for 1 hr is less than 0.25%.

[10]

A polarizing plate comprising a cellulose ester film described in any one of [1] to [9].

[11]

A liquid crystal display device comprising a polarizing plate described in [10].

### DETAILED DESCRIPTION OF THE INVENTION

A cellulose ester film according to an exemplified embodiment of the present invention has excellent film surface shape and a small change in humidity of Rth, and can prevent the occurrence of optical nonuniformity on the display surface thereof when applied to a liquid crystal display device. A change in performance of a film itself is small, and thus, highly-reliable polarizing plate and liquid crystal display device can be provided by using the cellulose ester film.

According to an exemplified embodiment of the present invention, the occurrence of optical nonuniformity has been reduced, and a highly-reliable liquid crystal display device can be provided.

Hereinafter, the present invention will be described in detail. In the present specification, when numerical values represent physical property values, characteristic values, and the like, the description “(numerical value 1) to (numerical value 2)” means “(numerical value 1) or more and (numerical value 2) or less”.

A cellulose ester film according to an exemplary embodiment of the present invention is a cellulose ester film including a cellulose ester and at least one kind of polyester, and the polyester has a number average molecular weight of 2,500 or less and the ratio of components having a molecular weight of 500 or less in the polyester is less than 8%.

The polyester included in the cellulose ester film has such a molecular weight distribution that a number average molecular weight of the polyester (i.e., a number average molecular weight of all the components in the polyester) is 2,500 or less and a ratio of components having a molecular weight of 500 or less is less than 8%. By adding the polyester having such a molecular weight distribution, a change in humidity of Rth can become small, the occurrence of optical nonuniformity on the display surface thereof can be prevented, and a change in performance of the film itself can also be prevented.

(Polyester Additive)

Polyester used in the cellulose ester film of the present invention will be described.

The polyester may be obtained by a known method such as a dehydrative condensation reaction of polyvalent basic acid and polyvalent alcohol, addition and dehydrative condensation reaction of polyvalent alcohol and anhydrous dibasic acid and, and the like, and thus, the polyester is one of oligomers of a polycondensed ester preferably formed from dibasic acid and diol and a derivative thereof (in the present specification, referred to as “polycondensed ester”).

The structure, molecular weight, and added amount of polyester may be selected such that the polyester is compatible with a dope of cellulose ester and a cellulose ester film satisfies desired optical properties and other performances.

In the cellulose ester film of the present invention, polyester is contained in an amount of preferably 30% or more by mass (by weight), more preferably 30% to 100% by mass, even more preferably 30% to 80% by mass, and most preferably 35% to 55% by mass, based on cellulose ester. The content is preferably 30% by mass or more since the optical nonuniformity can be reduced, and the content is preferably 100% by mass or less since a bleed out from the film is easily prevented. When two or more kinds of polyesters are included, the total content of the corresponding two or more kinds of polyesters may be within the above ranges.

A number average molecular weight (Mn) of the polyester in the present invention may be obtained from gel permeation chromatography (GPC).

In the present invention, the number average molecular weight of polyester is 2,500 or less, preferably 400 to 2,500, more preferably 500 to 2300, even more preferably 600 to 1800, and most preferably 800 to 1400. The change in humidity of Rth can be prevented by using a polyester having a number average molecular weight of 2,500 or less, and thus, optical nonuniformity can be reduced. When the content is 400 or more, the volatilization of polyester in the preparation process may be inhibited in combination with the following technology which removes low-molecular weights.

In the polyester in the present invention, a ratio (fraction by weight) of components having a molecular weight of 500 or less is preferably less than 8% and more preferably less than 7%. The ratio of components having a molecular weight of 500 or less may be obtained from gel permeation chromatography (GPC).

When the cellulose ester film is formed, volatilizing polyester components are low-molecular weight components, and as described above, the use of a polyester with an inhibited ratio of low-molecular weight components having a molecular weight of 500 or less can significantly reduce the contamination of the preparation process. After the film is formed, the bleed out of polyester from the cellulose ester film is also prevented, and in particular, the effect obtained by adding polyester (for example, reduction of humidity dependence of Rth) may be effectively exhibited using a much lower adding amount.

In order to set the ratio of low-molecular weight components to less than 8%, methods by distillation such as typical vacuum distillation, thin film (molecular) distillation, and the like, or chromatography may be exemplified, but a thin film distillation, by which low-molecular weight components may be removed in a short time, is preferred.

When the polyester is the polycondensed ester as mentioned above, dicarboxylic acid may be preferably exemplified as a dibasic acid constituting the corresponding polycondensed ester.

Examples of the dicarboxylic acid include an aliphatic dicarboxylic acid, an aromatic and the like, and thus any of the dicarboxylic acid may be used, and in particular, an aliphatic dicarboxylic acid may be preferably used.

Among the aliphatic dicarboxylic acids, an aliphatic dicarboxylic acid having 3 to 8 carbon atoms is preferable, and in particular, an aliphatic dicarboxylic acid having 4 to 6 carbon atoms is more preferable. The aliphatic dicarboxylic acid having lower carbon atoms may reduce the moisture vapor permeability of a cellulose ester film, and is also appropriate even in terms of compatibility with cellulose ester.

Specific compounds of the aliphatic dicarboxylic acid include succinic acid, maleic acid, adipic acid, glutaric acid and the like, and they may be used either alone or in combination of two or more thereof. Succinic acid, adipic acid, or mixtures thereof are preferable, and adipic acid is more preferable.

A diol constituting the polycondensed ester is exemplified by an aliphatic diol, an aromatic diol, and the like, and an aliphatic diol is particularly preferable.

Among the aliphatic diols, an aliphatic diol having 2 to 4 carbon atoms is preferable, and an aliphatic diol having 2 to 4 carbon atoms is more preferable. This is due to the fact that an aliphatic diol having lower carbon atoms has excellent compatibility with a cellulose ester dope or a cellulose ester film, and excellent bleed-out (drawing out) resistance to high temperature and high humidity treatment.

Examples of the aliphatic diol include ethylene glycol, diethylene glycol, 1,2-propylene glycol, 1,3-propylene glycol, butylenes glycol, and the like, and they may be used either alone or in combination of two or more thereof. Preferably, the diols are ethylene glycol, 1,2-propylene glycol, and 1,3-propylene.

The polyester in the present invention is preferably a polycondensed ester of an aliphatic dicarboxylic acid and an aliphatic diol particularly in terms of effects of the present invention.

A terminal of the polyester in the present invention may be an ester derivative of a monocarboxylic acid. That is, a terminal may be reacted with a monocarboxylic acid to be capped with the ester derivative of the monocarboxylic acid. Preferably, both terminals are capped with an ester derivative of a monocarboxylic acid.

As the monocarboxylic acid used for capping, an aliphatic monocarboxylic acid is preferably used, and acetic acid, propionic acid, butanic acid, benzoic acid, and a derivative thereof are preferable, acetic acid or propionic acid is more preferable, and acetic acid is the most preferable.

(Cellulose Ester)

Next, cellulose esters in the present invention will be described.

A cellulose ester used in the cellulose ester film of the present invention is an ester of cellulose and an acid as raw materials, preferably carboxylic acid ester having about 2 to 22 carbon atoms (so-called cellulose acylate), and more preferably a lower carboxylic acid ester having 6 or less carbon atoms.

Examples of the cellulose as a cellulose ester raw material used in the invention include cotton linter, wood pulp (broad leaf pulp, and needle leaf pulp) and the like, and a cellulose ester obtained from any raw material cellulose can be used. In some cases, a mixture thereof may be also used. Detailed descriptions on these raw material celluloses may be found in, for example, Lecture on Plastic Materials (17) Cellulose Resins (Maruzawa and Uda, THE NIKKAN KOGYO SHIMBUN, LTD., published in 1970) or Japan Institute of Invention and Innovation Journal of Technical Disclosure 2001-1745 (pp. 7 to 8), and the cellulose ester film of the present invention is not particularly limited thereto.

In the cellulose acylate preferably used in the present invention, although the degree of substitution of acetic acid and/or an aliphatic acid having 3 to 22 carbon atoms with a hydroxyl group of cellulose is not particularly limited, when the film is used as a polarizing plate and a liquid crystal display device, the degree of substitution of acyl with a hydroxyl group of cellulose is preferably 2.00 to 3.00 in order to impart moisture permeation or absorption which is appropriate for the film. The degree of substitution is preferably 2.30 to 2.98, more preferably 2.70 to 2.96, and even more preferably 2.80 to 2.94.

Examples of methods for measuring the degree of substitution of acetic acid and/or an aliphatic acid having 3 to 22 carbon atoms with a hydroxyl group of cellulose include a method in accordance with D-817-91 of ASTM or a NMR method.

Among acetic acid and/or an aliphatic acid having 3 to 22 carbon atoms substituted with a hydroxyl group of cellulose, the acyl group having 2 to 22 carbon atoms may be, but not particularly limited to, aliphatic or aromatic, and may be used either alone or in mixtures of two or more kinds thereof. Examples of the cellulose ester having an acyl group include alkylcarbonyl ester, alkenylcarbonyl ester, or aromatic carbonyl ester, aromatic alkyl carbonyl ester and the like of cellulose, each of which may have a group further substituted. Examples of preferred acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, cinnamoyl and the like. Among them, acetyl, propionyl, butanoyl, dodecanoyl, octadecanoyl, t-butanoyl, oleoyl, benzoyl, naphthylcarbonyl, cinnamoyl, and the like are preferred and acetyl, propionyl, and butanoyl are more preferred.

Among them, from the viewpoint of ease of synthesis, costs, ease of substituent distribution control and the like, an acetyl group alone, or a combination of an acetyl group and a propionyl group is preferred, and an acetyl group is particularly preferred.

The polymerization degree of cellulose acylate preferably used in the present invention is 180 to 700 as the viscosity average polymerization degree, and the polymerization degree of cellulose acetate is more preferably 180 to 550, even more preferably 180 to 400, and particularly preferably 180 to 350, as the viscosity average polymerization degree. When the polymerization degree is too high, a dope solution of the cellulose acylate tends to be too viscous to be manufactured into a film by casting. When the polymerization degree is too low, the strength of the manufactured film tends to be decreased. An average polymerization degree may be measured by the extreme viscosity method of Uda et al. (Kazuo Uda and Hideo Saito, Bulletin of The Society of Fiber Science and Technology, Japan, vol. 18, No. 1, pp. 105-120 (1962)). The method is described in detail in Japanese Patent Application Laid-Open No. Hei 9-95538.

The molecular weight distribution of the cellulose acylate preferably used in the present invention is evaluated by gel permeation chromatography, and it is preferred that the polydispersity index Mw/Mn (Mw is a mass average molecular weight and Mn is a number average molecular weight) is small, while the molecular weight distribution is narrow. Specific values of Mw/Mn are preferably 1.0 to 4.0, more preferably 2.0 to 3.5, and most preferably 2.3 to 3.4.

Removal of low-molecular components results in an increase in average molecular weight (polymerization degree) but makes the viscosity become lower than that of a typically used cellulose acylate, which is useful. A cellulose acylate having a small amount of low-molecular components may be obtained by removing low-molecular components from cellulose acylate synthesized by a typical method. The removal of the low-molecular components may be performed by washing the cellulose acylate with an appropriate organic solvent. When a cellulose acylate having a small amount of low-molecular components is prepared, an amount of a sulfuric acid catalyst in the acetification reaction is preferably adjusted to 0.5 to 25 parts by mass, based on 100 parts by mass of cellulose. The amount of a sulfuric acid catalyst within the above-mentioned range makes it possible to synthesize cellulose acylate that is preferable in terms of the molecular weight distribution (with narrow molecular weight distribution). When the cellulose acylate is used for preparing a cellulose acylate film of the present invention, the cellulose acylate preferably has a water content of 2% by mass or less, more preferably 1% by mass or less, and particularly preferably 0.7% by weight or less. In general, it is known that the cellulose acylate contains water and a water content thereof is 2.5 to 5% by mass. In order to attain the aforementioned water content of the cellulose acylate in the present invention, drying is required, and the method thereof is not particularly limited as long as a desired water content may be attained. For the cellulose acylate of the present invention, a raw material cotton or a synthesizing method thereof are described in detail in Japan Institute of Invention and Innovation Journal of Technical Disclosure (Technical Publication No. 2001-1745, Mar. 15, 2001, published by Japan Institute of Invention and Innovation) pp. 7 to 12.

From the viewpoint of substituent, degree of substitution, polymerization degree, molecular weight distribution and the like, a single kind or two or more different kinds of cellulose acylate may be combined for use in the invention.

(Nitrogen-Containing Aromatic Compound)

It is preferred that the cellulose ester film of the present invention includes at least one nitrogen-containing aromatic compound.

It is preferred that the nitrogen-containing aromatic compound functions as a retardation controlling agent. The optical anisotropy of the cellulose ester film of the present invention is controlled by the addition of the aforementioned polyester, and the above nitrogen-containing aromatic compound may be further added according to a desired retardation.

It is preferred that the nitrogen-containing aromatic compound is a compound having at least two aromatic rings. It is preferable to exhibit the optically positive uniaxiality when a compound having at least two aromatic rings is uniformly oriented.

The molecular weight of the nitrogen-containing aromatic compound is preferably 300 to 1,200 and more preferably 400 to 1,000.

The content of the nitrogen-containing aromatic compound in the cellulose ester film of the present invention is preferably 0.1% to 6.0% by mass, more preferably 0.5% to 5.0% by mass, and particularly preferably 1.0% to 4.5% by mass based on the cellulose ester.

As the nitrogen-containing aromatic compound, those described in paragraphs [0026] to [0115] of WO2011/040468 may be preferably used.

(Additive)

An anti-degradation agent (for example, antioxidant, peroxide decomposing agent, radical inhibitor, metal inactivating agent, acid trapping agent and amine) may be added to the cellulose ester film. The anti-degradation agent is described in Japanese Patent Application Laid-Open Nos. Hei 3-199201, Hei 5-194789, Hei 5-271471 and Hei 6-107854. The adding amount of the anti-degradation agent is preferably 0.01% to 1% by mass and more preferably 0.01% to 0.2% by mass, of the solution (dope) to be prepared from the viewpoint of exhibiting the effects of the present invention and inhibiting the bleed-out of the anti-degradation agent on the surface of the film.

Particularly preferable examples of the anti-degradation agent include butylated hydroxytoluene (BHT) and tribenzylamine (TBA).

An UV absorber may be added to the cellulose ester film of the present invention. As the UV absorber, a compound described in Japanese Patent Application Laid-Open No. 2006-282979 (benzophenone, benzotriazole, and triazine) is preferably used. Two or more UV absorbers may be used in combination.

As the UV absorber, benzotriazole is preferred, and specifically, TINUVIN328, TINUVIN326, TINUVIN329, TINUVIN571, ADEKASTAB LA-31, and the like are exemplified.

The amount of the UV absorber to be added is preferably 10% or less, more preferably 3% or less, and most preferably 0.05% to 2%, by mass based on the cellulose ester.

(Matting Agent Fine Particles)

It is preferred that the cellulose ester film of the present invention contains fine particles as a matting agent. Examples of the fine particles used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferred in that the turbidity is reduced, and silicon dioxide is particularly preferred. It is preferred that fine particles of silicon dioxide have an average primary particle diameter of 20 nm or less and an apparent specific gravity of 70 g/L or more. Those having a small average particle diameter of primary particles as from 5 nm to 16 nm are more preferred because the haze of the film may be reduced. The apparent specific gravity is preferably 90 g/L to 200 g/L, and more preferably 100 g/L to 200 g/L. A larger apparent specific gravity is preferred because a dispersion with a high concentration may be prepared and thus the haze and the agglomerated material are excellent.

Preferred embodiments thereof are described in detail in Japan Institute of Invention and Innovation Journal of Technical Disclosure (Technical Publication No. 2001-1745, Mar. 15, 2001, published by Japan Institute of Invention and Innovation) pp. 35 to 36, and may be preferably used even in the cellulose ester film of the present invention.

(Manufacturing Method of Cellulose Ester Film)

(Organic Solvent of Dope Solution)

In the present invention, a cellulose ester film is preferably manufactured by a solvent cast method, and the film is manufactured by using a solution (dope) obtained by dissolving a polymer including cellulose ester in an organic solvent.

An organic solvent preferably used as a main solvent of the dope is not particularly limited so long as polymers including the cellulose ester are dissolved in the organic solvent, but solvents selected from esters having 3 to 12 carbon atoms, ketone, ether, and halogenated hydrocarbons having 1 to 7 carbon atoms are preferred. The ester, ketone, and ether may have a cyclic structure. Compounds having two or more of any of ester, ketone and ether functional groups (that is, —O—, —CO— and —COO—) may also be used as a main solvent, and may have other functional groups, for example, alcoholic hydroxyl groups.

As described up to this point, for the cellulose acylate film of the present invention, a chlorine-based hydrocarbon halide may be used as a main solvent. As described in Japan Institute of Invention and Innovation Journal of Technical Disclosure No. 2001-1745 (pp. 12 to 16), a non-chlorine-based solvent may be used as a main solvent, and the optical film of the present invention is not particularly limited.

Solvents in dope solutions and films relating to the present invention as well as dissolving methods thereof are disclosed in the following patents, which are a preferred aspect. These solvents and methods are disclosed, for example, in Japanese Patent Application Laid-Open Nos. 2000-95876, 2000-95877, Hei 10-324774, Hei 8-152514, Hei 10-330538, Hei 9-95538, Hei 9-95557, Hei 10-235664, 2000-63534, Hei 11-21379, Hei 10-182853, Hei 10-278056, Hei 10-279702, Hei 10-323853, Hei 10-237186, Hei 11-60807, Hei 11-152342, Hei 11-292988, Hei 11-60752, Hei 11-60752, and the like. According to these patents, there are descriptions not only about solvents preferable for dissolving the cellulose ester of the present invention but also about properties of the solutions or substances that may added to the solutions, and the descriptions are a preferred aspect even in the present invention.

(Dissolution Process)

The dissolution method in the preparation of the dope solution relating to the present invention is not particularly limited, and any method such as a room-temperature dissolving method, a cold dissolving method, a hot dissolving method, and a combination thereof may be used. With respect to each process of preparation of a dope solution and concentration and filtration of solutions according to the dissolution process, the preparation processes described in detail in Japan Institute of Invention and Innovation Journal of Technical Disclosure (Technical Publication No. 2001-1745, Mar. 15, 2001, published by Japan Institute of Invention and Innovation), pp. 22 to 25, are preferably used in the present invention.

(Casting, Drying and Winding Processes)

Next, a method for manufacturing a film by using a dope solution relating to the present invention will be described. A method and apparatus for manufacturing an optical film of the present invention may use solution casting film formation methods and solution casting film formation devices that are provided in the manufacture of a cellulose triacetate film in the related art. A dope solution prepared in a dissolver (tank) is once stored in a storage tank, and bubbles included in the dope are defoamed to perform a final preparation. The resulting dope is fed from a dope exit to a pressure die through for example, a pressure constant displacement gear pump capable of precisely metering and transporting solutions according to the number of rotations and uniformly cast from an inlet member (slit) of the pressure die on an endlessly moving metal support of a casting portion and at a peeling point where the metal support makes almost one revolution, a half-dried doping film (also referred to as a web) is peeled off the metal support. Both edges of the web thus obtained are fixed therebetween by a clip, conveyed and dried by a tenter while the width thereof is maintained, and the film subsequently obtained is mechanically conveyed with a roll group in a heating apparatus and wound in the form of a roll by a winder to a predetermined length. The combination of the tenter and the drying apparatus of the roll group varies depending on the purpose. In another aspect, it is possible to employ various methods of forming a film by using a solvent casting method such as a method including the following process: the doping extruded from a die gels onto a drum which cools the above-described metal support to 5° C. or less, and then at a time point when the metal support makes almost one revolution, is removed from the drum, conveyed while being stretched by a pin-type tenter, and dried.

In the cellulose ester film of the present invention, it is preferable to perform casting by a co-casting method. That is, a casting having a plurality of layers is performed by extruding at least two or more dopes which are different in the amount of addition simultaneously or sequentially from an inlet member of a die. In this case, the absolute value of the difference (Δc=c2−c1) between the content (c1 (phr)) of additives in at least one dope solution and the content (c2 (phr)) of additives of a dope solution to form another layer is 2 phr or more, preferably 5 phr to 150 phr, more preferably 10 phr to 100 phr, and even more preferably 20 phr to 50 phr. It is also preferable to control the thickness of each layer. For example, the contamination of a casting support may be inhibited to reduce the haze of a film or decrease the content of additives of the film on the surface thereof by disposing a layer having a small amount of addition as a layer in contact with the casting support or increasing the film thickness of the layer, and thus these factors may be appropriately controlled while a balance with other required characteristics is confirmed.

It is preferable to be c1>c2.

It is preferred that layers to be formed as c1 and c2, respectively, have a thicker thickness, and a layer to be formed from c1 has a thickness (D1) of preferably 1 μm to 30 μm, more preferably 3 μm to 20 μm, and even more preferably 5 μm to 15 μm. A layer to be formed from c2 has a thickness (D2) of preferably 1 μm to 30 μm, more preferably 3 μm to 20 μm, and even more preferably 5 μm to 15 μm.

Thicknesses D1 and D2 may be the same as or different from each other. When D1 and D2 are the same as each other, it is preferable from the viewpoint of curls of the film. When D1 and D2 are different from each other, the manufacturing compatibility may be imparted by combining the characteristic difference between front and rear surfaces of a film or web, or the surface hardness may be imparted or the surface shape of the film may be improved while effects of improving the display nonuniformity of an image display device are maintained by maintaining the total amount of addition of the film.

In the co-casting, the haze of the film or the content of additives on the surface of the film may be controlled even by controlling the concentration of a solid of a layer in contact with the casting support. For example, it may be difficult to transfer the surface shape of the casting support by reducing the concentration of a solid in the layer. That is, the drying rate in the dope (web) including large amounts of additives is fast and thus when the film is peeled off from the casting support, the residual solvent amount is small and it is difficult to perform a leveling in the subsequent process. Accordingly, the film haze is easily increased, but the surface shape (unevenness) responsible for an increase in haze is negligibly small and thus it is possible to reduce the haze by locally reducing the concentration of a solid.

Meanwhile, the diffusivity of additives may be inhibited by increasing the concentration of the solid in the layer and thus the contamination of the casting support may be inhibited or the content of the additives on the surface of the film may be reduced. As described above, these factors may be appropriately controlled while a balance with other required characteristics is confirmed.

When the co-casting is performed, for example, a feed blocking method by which the number of layers is easily controlled or a multi-manifold method which has excellent thickness precision in each layer may be used, and a feed blocking method may be more preferably used in the present invention.

In a solution casting film formation method used in a functional protective film which is an optical member for electronic displays or a silver halide photographic light-sensitive material, which are the primary uses of the cellulose ester film of the invention, a coating device is often combined with a solution casting film formation device to provide a surface processing on a film such as an undercoat layer, an antistatic layer, an anti-halation layer, a protective layer, and the like. The devices are described in detail in Japan Institute of Invention and Innovation Journal of Technical Disclosure (Technical Publication No. 2001-1745, Mar. 15, 2001, published by Japan Institute of Invention and Innovation), pp. 25 to 30, and classified into casting (including co-casting), metal support, drying, peeling, and the like, which may be preferably used in the present invention.

(Heat Treatment Process)

In the manufacturing method of the cellulose ester film of the present invention, a process of subjecting the cellulose ester film to additional heat treatment may be applied if necessary. Although the effects of the heat treatment process are not particularly limited, it is believed that for example, a coefficient of hygroscopic expansion may be changed by performing heat treatments in which temperature and tensile strength are controlled according to the kind of the film to change the orientation or crystallization of cellulose ester molecules to be included.

(Thickness of Film)

The cellulose ester film of the present invention preferably has a thickness of 20 μm to 120 more preferably 30 μm to 90 μM, and particularly preferably 35 μm to 80 μM. For use as a polarizer protective film attached to a liquid crystal panel, the thickness is preferably 30 μm to 80 μm, more preferably 35 μm to 65 and particularly preferably 35 μm to 50 μm for reducing optical nonuniformity. When the film thickness is within this range, warpage of the panel according to changes in temperature and humidity may be reduced.

(Retardation)

The cellulose ester film of the present invention has an in-plane retardation Re of preferably 0 nm to 5 nm at 25° C. and 60% RH. A retardation Rth in a thickness direction of the film is preferably −20 to 10 nm at 25° C. and 60% RH and more preferably −15 nm to −5 nm.

Where, Re and Rth are defined as the following equations (I) and (II) and are values for light of 590 nm in wavelength.

Re=(nx−ny)×d(nm) Equation (I)

Rth={(nx+ny)/2−nz}×d(nm) Equation (II)

(where nx is a refractive index in a slow axis direction in the plane of the film, ny is a refractive index in a fast axis direction in the plane of the film, nz is a refractive index in a thickness direction of the film, and d is a thickness of the film (nm).)

When Re and Rth are within the above-described ranges, the contrast of a display screen of a liquid crystal display device may be enhanced, or viewing angle characteristics or tint thereof may be improved.

In the present specification, Re and Rth (unit: nm) are obtained according to the following method.

First, a film is humidity controlled at 25° C. and 60% RH for 24 hours, and then the average refractive index (n) represented by the following Equation (2) is obtained by using a prism coupler (MODEL2010 Prism Coupler: manufactured by Metricon) and using a solid state laser of 532 nm at 25° C. and 60% RH.

n=(n_{TE}×2+n_{TM})/3 Equation (2):

[where n_{TE} is a refractive index measured using light polarized in the plane direction of the film, and n_{TM} is a refractive index measured using light polarized in the normal direction of the film surface.]

Next, Re (λ nm) is measured by irradiating with an incident light having a wavelength of λ nm in the normal direction of the film using KOBRA 21ADH or WR (manufactured by Oji Scientific Instruments Co., Ltd.).

When a film to be measured is represented by a uniaxial or biaxial refractive index ellipsoid, Rth (λ nm) is calculated by the following method.

A total of six points of Re (λ nm) are measured by irradiating with an incident light having a wavelength of λ nm from each of the inclined directions at an angle increasing in 10° step increments up to 50° in one direction from the normal direction of the film by taking the in-plane slow axis (decided by KOBRA 21ADH or WR) as an inclined axis (axis of rotation) (when there is no slow axis, any in-plane direction of the film will be taken as an axis of rotation), and then Rth (λ nm) is calculated by KOBRA 21ADH or WR based on the retardation value measured, the average refractive index, and the film thickness value inputted.

When λ is not particularly described and only described with Re and Rth in the above description, it means that values are measured by using light a wavelength of 590 nm. In the case of a film having a direction in which a retardation value is zero at a certain tilt angle from the normal direction about the in-plane slow axis as an axis of rotation, a retardation value at a tilt angle greater than that certain tilt angle is changed into a minus sign, and then is calculated by KOBRA 21ADH or WR.

Rth may also be calculated based on two retardation values measured in two different directions at any angle by taking the slow axis as an inclined axis (when there is no slow axis, any in-plane direction of the film will be taken as an axis of rotation), the average refractive index, and the film thickness inputted and from the following Equations (3) and (4).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ ) }{ nx} ) )} \qquad Equation ( 3 )$$

(where Re (θ) represents a retardation value in a direction inclined by an angle (θ) from the normal direction. nx represents a refractive index in an in-plane slow axis direction, ny represents a refractive index in an in-plane direction perpendicular to nx, nz represents a refractive index in a thickness direction perpendicular to nx and ny, and d is a film thickness.)

Rth=((nx+ny)/2−nz)×d Equation (4):

When a film to be measured is not represented by a uniaxial or biaxial refractive index ellipsoid, so-called, when the film has no optic axis, Rth (knm) is calculated in the following manner.

Eleven points of Re (λ, m) are measured by irradiating with an incident light having a wavelength of λ nm from each of the inclined directions at an angle increasing in 10° step increments from −50° to +50° in one direction from the normal direction of the film by taking the in-plane slow axis (decided by KOBRA 21ADH or WR) as an inclined axis (axis of rotation), and then Rth (λ nm) is calculated by KOBRA 21ADH or WR based on the retardation value measured, the average refractive index, and the film thickness value inputted. nx, ny, and nz are calculated by inputting these average refractive index values and the film thickness into KOBRA 21ADH or WR. Nz=(nx−nz)/(nx−ny) is further calculated from the thus calculated nx , ny, and nz.

In the above measurements, values described in a polymer handbook (John Wiley & Sons, Inc.) and catalogues of various optical films may be used as the average refractive index. For films whose average refractive index is unknown, the value may be measured by using the above-described method. Values of average refractive indices of main optical films are illustrated below: Cellulose acylate (1.48), cycloolefin polymer (1.52), polycarbonate (1.59), polymethyl methacrylate (1.49) and polystyrene (1.59).

(Humidity Dependence)

In the cellulose ester film of the present invention, it is preferred that a difference between a retardation Rth (10% RH) in a thickness direction at 25° C. and 10% RH and a retardation Rth (80% RH) in a thickness direction at 25° C. and 80% RH satisfies the following equation.

Rth(10% RH)−Rth(80% RH)<8 nm

A highly reliable liquid crystal display device may be provided by reducing the change in Rth when the humidity is change. By reducing the ΔRth of the cellulose ester film of the present invention, preferred effects are obtained in that circular color nonuniformity which is visible when a liquid crystal display device is observed from a surface inclined to the display surface is reduced.

For Rth (H % RH) at 25° C. and H % RH, a film is humidity-controlled at 25° C. and 60% RH for 24 hr, and then bound to a glass plate through an adhesive at 25° C. and 60%. The Rth (H % RH) is calculated by humidity controlling the resulting plate at 60° C. and 90% RH for 48 hr, humidity conditioning the plate at 25° C. and H % RH for 24 hr, and measuring the Rth value at a measuring wavelength of 590 nm and H % RH in the same manner as in the method described above at 25° C. and H % RH.

(Weight Reduction Rate of Film)

When the cellulose ester film of the present invention is maintained at 140° C. for 1 hr, the film has a weight reduction rate of preferably less than 0.25%, more preferably less than 0.15%, and even more preferably less than 0.10%. When the weight reduction rate is less than 0.25%, the fact means that the volatilization of additives such as polyester and the like is suppressed from the cellulose ester film, and the generation of changes in optical or mechanical performance (for example, deterioration of film surface) may be prevented.

The weight reduction rate of a film may be measured by TG-DTA (differential thermal weight measurement). The film weight reduction rate may be calculated from the following equation.

Weight reduction rate (%)=(weight change at 140° C. for 1 hr/initial film weight)×100

(Elastic Modulus of Film)

The circular color nonuniformity which is visible when a liquid crystal display device is observed from an inclined surface may be more difficult to be visible even by reducing the elastic modulus of the film. A tensile elastic modulus of the cellulose ester film of the present invention is preferably less than 3.0 GPa, more preferably 1.0 GPa to 3.0 GPa, and even more preferably 1.2 GPa to 2.8 GPa. As a specific measuring method, the elastic modulus is calculated from the slope by measuring the stress at 0.1% elongation and the stress at 0.5% elongation at a tension rate of 10%/min in an atmosphere of 25° C. and 60% RH with a universal tensile tester “STM T50BP” manufactured by Toyo Baldwin Co., Ltd. In the measurement of elastic modulus, elastic modulus anisotropy may be obtained by changing the azimuth of cutting out the specimen, and the angle θ between the conveying direction during manufacture and the azimuth in which elastic modulus is the highest is not particularly limited, but is preferably 0±10° or 90±10°. Meanwhile, the azimuth in which elastic modulus is the highest may be evaluated as a direction in which a sound propagation velocity to be described below is the highest.

Although details on the relationship between the tensile elastic modulus (hereinafter described) of the film and the visibility of color nonuniformity when a liquid crystal display device is observed from the inclined surface are unclear, it may be considered that by reducing a tensile elastic modulus of a film, the film is capable of reducing the internal stress generated with environmental humidity changes, while being in a state fixed to a highly rigid support such as glass, and as a result, the variations in retardation of the film may be further suppressed.

(Haze of Film)

The cellulose ester film of the present invention preferably has a low haze, and the haze is preferably 0.01% to 2.0%. The haze is more preferably 1.0% or less, and even more preferably 0.5% or less. However, since the haze of the film of the present invention predominantly has surface haze components resulting from the surface shape, the components are eliminated, for example, if an adhesion bond is used to attach the film to a polarizer or an adhesive is coated to change the shape of the surface, and thus even the haze values higher than the values in the preferred range do not have any effects on display characteristics of a liquid crystal display device. However, haze nonuniformity, which is visible in portions where pressure is applied or not applied is problematic for a film appearance when used as the optical film. Thus, haze nonuniformity which is evaluated as a haze distribution of the film of the present invention is preferably 0.5% or less, more preferably 0.3% or less, even more preferably 0.1% or less, and most preferably 0.05%. Measurement of haze may be conducted with a optical film sample of the present invention having 40 mm×80 mm at 25° C. and 60% RH in accordance with JIS K-6714 by using a haze meter (HGM-2DP, manufactured by Suga Test Instruments Co., Ltd.), and the like.

(Surface Roughness (Ra))

The surface of the cellulose ester film of the present invention was observed in an AFM mode by using a scanning probe microscope (SPA400, manufactured by SII NanoTechnology Inc.) to obtain a surface average surface roughness (Ra) in a range of 100 μm×100 μm. The optical film of the present invention preferably has a surface roughness of 50 nm or less. It is preferred to have a roughness of 50 nm or less from the viewpoint of reducing the haze of the film. It is preferred to have a roughness of 1 nm or more from the viewpoint of the sliding property of a base or the adhesion with a polarizer. The surface roughness is preferably 1 nm to 30 nm, more preferably 1 mm to 10 nm, even more preferably 1.5 nm to 5 nm, and most preferably 1.5 nm to 3 nm. When the surface roughness is more than 3 nm, it is preferred to have a surface hardness within a range to be described below.

(Spectroscopic Characteristics, Spectral Transmissivity)

Transmissivity may be measured at a wavelength of 300 nm to 450 nm at 25° C. and 60% RH with a spectrophotometer “U-3210” {Hitachi Ltd.} by preparing a 13 mm×40 mm sample of a cellulose ester film. The inclination width may be obtained with a 72% wavelength to a −5% wavelength. The threshold wavelength may be represented by (inclination width/2)+5% wavelength, and absorption edge may be represented by a wavelength with 0.4% transmissivity. Transmissivities at 380 nm and 350 nm may be evaluated from this.

When the cellulose ester film of the present invention is used on a side facing a protective film to contact the liquid crystal cell of a polarizing plate, it is preferred that the spectral transmissivity measured at a wavelength of 380 nm is 45% to 95%, and the spectral transmissivity measured at a wavelength of 350 nm is 10% or less.

(Equilibrium Water Content of Film)

The water content (equilibrium water content) of the cellulose ester film of the present invention is not particularly limited, but does not harm the adhesion with an aqueous polymer, such as polyvinyl alcohol, and the like when the film is used as a protective film for a polarizing plate. Thus, the water content is preferably 0% to 4% by mass at 25° C. and 80% RH regardless of the film thickness. The water content is more preferably 0.1% to 3.5% by mass and particularly preferably 1% to 3% by mass. With the equilibrium water content of 4% by mass or less, the film is prevented from having too much humidity dependence of retardation, which is preferred for use as a support of a retardation film.

The water content was measured by a Karl-Fischer's method on a sample 7 mm×35 mm of the cellulose ester film of the present invention using a moisture meter “CA-03” and a sample drying device “VA-05”, {both of which are manufactured by Mitsubishi Chemical Corp.}. The measured amount of water (g) is divided by the sample mass (g) to give a water content.

(Moisture Vapor Permeability of Film)

The moisture vapor permeability of the film is measured under conditions of 40° C. and 90% RH based on JIS Z-0208. The moisture vapor permeability of the optical film of the present invention is not particularly limited but preferably is 50 to 1,500 g/m²·24 h. The value is more preferably 100 to 1,000 g/m²·24 h and particularly preferably 200 to 800 g/m²⁰·24 h. If the moisture vapor permeability is within the range, the processability of a polarizing plate and the durability of the polarizing plate to humidity or humid heat are compatible, which is preferred.

(Photoelastic Coefficient)

When the cellulose ester film of the present invention is used as a protective film for a polarizing plate, there may be a change in birefringence (Re, Rth) due to the stress accompanying the shrinkage of a polarizer. Such a change in birefringence due to the stress may be determined in terms of photoelastic coefficient, but the range thereof is preferably 15×10¹² Pa⁻¹ or less (15 Br or less), more preferably −5×10¹² Pa⁻¹ to 12×10¹² Pa⁻¹, and even more preferably −2×10¹² Pa⁻¹ to 11×10¹² Pa⁻¹.

(Contact Angle of Film Surface by Alkali Saponification Treatment)

An alkali saponification treatment may be mentioned as one of the effective means of the surface treatment when the cellulose ester film of the present invention is used as a protective film of a polarizing plate. In this case, the contact angle of the film surface after the alkali saponification treatment is preferably 55° or less. The contact angle of the film surface is more preferably 50° or less, and even more preferably 45° or less.

(Surface Treatment)

The cellulose ester film of the present invention may be subjected to a surface treatment to achieve the improvement of the adhesion between the cellulose ester film and respective functional layers (for example, an undercoat layer and a back layer). For example, a glow discharge treatment, an ultraviolet irradiation treatment, a corona treatment, a flame treatment, and an acid or alkali treatment may be used. As used herein, the glow discharge treatment may be a low temperature plasma caused under a low pressure gas of 10⁻³ Torr to 20 Torr, and further preferably a plasma treatment under an atmospheric pressure. The plasma excitable gas denotes a gas that may be excited into plasma under the conditions as described above, and includes argon, helium, neon, krypton, xenon, nitrogen, carbon dioxide, flons such as tetrafluoromethane, mixtures thereof, and the like. These gases are described in detail in Japan Institute of Invention and Innovation Journal of Technical Disclosure (Technical Publication No. 2001-1745, Mar. 15, 2001, published by Japan Institute of Invention and Innovation) pp. 30 to 32, which may be preferably used in the present invention.

(Functional Layer)

The cellulose ester film of the present invention is applied to, for example, an optical use and a photographic photosensitive material as the uses thereof. In particular for the optical use, it is preferred that the film is used as a protective film of a polarizing plate and thus the polarizing plate is used in a liquid crystal display device. The liquid crystal display devices are preferably of TN, IPS, FLC, AFLC, OCB, STN, ECB, VA and HAN.

In this case, imparting of various functional layers is carried out on the cellulose ester film of the present invention. Examples thereof include an antistatic layer, a curable resin layer (transparent hard coat layer), an antireflection layer, an easy-to-adhere layer, an antiglare layer, an optically-compensatory layer, an alignment layer, a liquid crystal layer, and the like. The functional layers and materials thereof may include a surfactant, a slipping agent, a matting agent, an antistatic layer, a hard coat layer, and the like, and are described in details in Japan Institute of Invention and Innovation Journal of Technical Disclosure (Technical Publication No. 2001-1745, Mar. 15, 2001, published by Japan Institute of Invention and Innovation) pp. 32 to 45, which may be preferably used in the invention.

<<Retardation Film>>

The cellulose ester film of the present invention may be used as a retardation film. The “retardation film” is generally used in display devices such as liquid crystal display device, and the like, means an optical material having optical anisotropicity, and is synonymous with a phase difference plate, an optically compensatory film, an optically compensatory sheet, and the like. In the liquid crystal display device, the retardation film is used for the purpose of enhancing the contrast of a display screen or improving viewing angle characteristics or tint.

Retardation may be freely controlled by using the cellulose ester film of the present invention, and thus a retardation film having excellent adhesion with a polarizer may be manufactured.

The cellulose ester film of the present invention may be used as a retardation film by stacking a plurality of optical films of the present invention or stacking the optical film of the present invention with a film out of the present invention to control Re or Rth appropriately. The stacking of films may be performed by using an adhesive or an adhesion bond.

In some cases, the cellulose ester film of the present invention may be used as a support of a retardation film, and then, by providing an optically anisotropic layer including a liquid crystal and the like thereon, a retardation film is formed. The optically anisotropic layer applied to the retardation film may be formed as, for example, a composition containing a liquid crystalline compound, a polymer film having birefringence, and the optical film of the present invention. In this case, when the manufacturing method of the present invention is performed as a subsequent process of an optically anisotropic layer forming process, it is preferred to bring an organic solvent in contact with a surface opposite to the surface on which the optically anisotropic layer is formed.

As the liquid crystalline compound, discotic liquid crystalline compounds or rod-like liquid crystalline compounds are preferred.

(Discotic Liquid Crystalline Compounds)

Examples of discotic liquid crystal compounds that may be used as the liquid crystalline compounds include compounds described in various documents (for example, C. Destrade et al., Mol. Crysr. Liq. Cryst., vol. 71, page. 111 (1981); edited by the Chemical Society of Japan, Quarterly Issue Chemistry Review Paper, No. 22, Chemistry of Liquid Crystal, Ch. 5, Ch. 10, Sec. 2 (1994); B. Kohne et al., Angew. Chem. Soc. Chem. Comm., page 1794 (1985); and J. Zhang et al., J. Am. Chem. Soc., vol. 116, page 2655 (1994)).

In the optically anisotropic layer, the discotic liquid crystalline molecules are preferably fixed in an aligned state, and are most preferably fixed by a polymerization reaction. The polymerization of discotic liquid crystalline molecules is described in Japanese Patent Application Laid-Open No. Hei 8-27284. In order to fix the discotic liquid crystalline molecules by polymerization, it is necessary to bind a polymerizable group to the discotic core of the discotic liquid crystalline molecules as a substituent. However, when the polymerizable group is directly bound to the discotic core, it becomes difficult to maintain the orientation state for the polymerization reaction. Thus, a linking group is introduced between the discotic core and the polymerizable group. The discotic liquid crystal molecules having a polymerizable group are described in Japanese Patent Application Laid-Open No. 2001-4387.

(Rod-Like Liquid Crystalline Compounds)

Examples of rod-like liquid crystalline compounds that may be used as the liquid crystalline compounds include azomethines, azoxy compounds, cyanobiphenyls, cyanophenyl esters, benzoic esters, phenyl esters of cyclohexanecarboxylic acid, cyanophenylcyclohexanes, cyano-substituted phenylpyrimidines, alkoxy-substituted phenylpyrimidines, phenyldioxanes, tolans and alkenylcyclohexylbenzonitriles. As the rod-like liquid crystalline compounds, not only low molecular liquid crystalline compounds, but also high molecular liquid crystalline compounds may be useful.

In the optically anisotropic layer, the discotic liquid crystalline molecules are preferably fixed in an aligned state, and are most preferably fixed by a polymerization reaction. Examples of polymerizable rod-like liquid crystalline compounds that may be used in the present invention include compounds described, for example, in Makromol. Chem., vol. 190, page 2255 (1989), Advanced Materials, vol. 5, page 107 (1993), U.S. Pat. Nos. 4,683,327, 5,622,648, and 5,770,107, International Publication Nos. WO95/22586, WO95/24455, WO97/00600, WO98/23580, and WO98/52905, and Japanese Patent Application Laid-Open Nos. Hei 1-272551, Hei 6-16616, Hei 7-110469, Hei 11-80081, 2001-328973, and the like.

<<Polarizing Plate>>

The polarizing plate of the present invention includes at least one cellulose ester film of the present invention.

The cellulose ester film of the present invention may be used as a protective film of the polarizing plate (the polarizing plate of the invention). The polarizing plate of the present invention includes a polarizer and two polarizing plate protective films (optical films) that protect both sides thereof, and the cellulose ester film of the present invention is particularly preferably used as a polarizing plate protective film on at least one side.

When the cellulose ester film of the present invention is used as the polarizing plate protective film, the cellulose ester film of the present invention is preferably subjected to a surface treatment for hydrophilization, such as the above described surface treatments (also described in Japanese Patent Application Laid-Open Nos. Hei 6-94915 and Hei 6-118232), and for example, a glow discharge treatment, a corona discharge treatment, an alkali saponification treatment, and the like are preferably performed. As the surface treatment, an alkali saponification treatment is used most preferably.

The polarizer may be prepared by, for example, immersing a polyvinyl alcohol film in an iodine solution and stretching the film. When the polarizer prepared by immersing a polyvinyl alcohol film in an iodine solution and stretching the film is used, the optical film of the invention can be attached on its surface treated side directly to both sides of the polarizer with an adhesion bond applied therebetween. In the preparation method of the present invention, it is preferred that the optical film be directly attached to the polarizer in that way. Examples of the adhesion bonds include aqueous solutions of polyvinyl alcohol or polyvinyl acetal (for example, polyvinyl butyral) or latexes of vinyl polymers (for example, polybutyl acrylate). An aqueous solution of completely saponified polyvinyl alcohol is a particularly preferred adhesion bond.

A liquid crystal display device generally has a liquid crystal cell disposed between a pair of polarizing plates and therefore contains four polarizing plate protective films. While the optical film of the present invention may be used as any one or more of the four polarizing plate protective films, it is particularly advantageous to use the optical film of the present invention as the protective film disposed between the polarizer and the liquid crystal layer (liquid crystal cell) in a liquid crystal display device. A transparent hardcoat layer, an antiglare layer, an antireflective layer, and the like may be provided on the protective film disposed on the side opposite to the side of the optical film of the present invention between the polarizers and is particularly preferably used as the polarizing plate protective film of the outermost surface of the display side of a liquid crystal display device.

The polarizing plate is composed of a polarizer and a protective film that protects both sides thereof and combines and is further composed of a protective film on one side of the polarizing plate and a separate film on the other side thereof. Both the protective film and the separate film are used for the purpose of protecting the polarizing plate during shipment of the polarizing plate or inspection of the product. In this case, the protective film is attached for the purpose of protecting the surface of the polarizing plate, and the polarizing plate is used on the side opposite to the surface in contact with the liquid crystal plate. The separate film is used for the purpose of covering the adhesion bond layer which is attached to the liquid crystal plate, and used on the side which attaches the polarizing plate to the liquid crystal plate.

In the liquid crystal display device, a substrate including a liquid crystal is usually disposed between two polarizing plates, but the polarizing plate protective film to which the optical film of the present invention is applied may provide excellent display qualities even though the protective film may be disposed in any portion. In particular, a transparent hardcoat layer, an antiglare layer, an antireflective layer, and the like are provided on the protective film on the outermost surface on the display side of a liquid crystal display device, and thus the polarizing plate protective film is particularly preferably used on this portion.

<<Liquid Crystal Display Device>>

The cellulose ester film and polarizing plate of the present invention may be used for liquid crystal display devices of various display modes. Hereinafter, each of the liquid crystal modes in which these films may be used will be described. Among these modes, the cellulose ester film and polarizing plate of the present invention may be preferably used in all the modes, but are particularly preferably used for liquid crystal display devices of VA mode and IPS mode. These liquid crystal display devices may be any one of a transmissive type, a reflective type, and a semi-transmissive type.

(TN Type Liquid Crystal Display Device)

The cellulose ester film of the present invention is preferably used as a support of a retardation film in a TN type liquid crystal display device having a TN mode liquid crystal cell. TN mode liquid crystal cells and TN type liquid crystal display devices have long been known. The retardation film used in TN type liquid crystal display devices is described in Japanese Patent Application Laid-Open Nos. Hei 3-9325, Hei 6-148429, Hei 8-50206, and Hei 9-26572, and Mori et al., papers (Jpn. J. Appl. Phys., vol. 36 (1997), p. 143 or Jpn. J. Appl. Phys. Vol. 36 (1997), p. 1068).

(STN Type Liquid Crystal Display Device)

The cellulose ester film of the present invention may be used as a support of a retardation film in an STN type liquid crystal display device having an STN mode liquid crystal cell. In common STN type liquid crystal display devices, rod-like liquid crystal molecules in the liquid crystal cell are twisted in the range of 90° to 360°, and the product (And) of the refractive index anisotropy (An) of the rod-like crystal molecules and the cell gap (d) are in the range of 300 nm to 1500 nm. The retardation film used in STN type liquid crystal display devices is described in Japanese Patent Application Laid-Open No. 2000-105316.

(VA Type Liquid Crystal Display Device)

The cellulose ester film of the present invention is particularly advantageously used as a retardation film or a support of the retardation film in a VA type liquid crystal display device having a VA mode liquid crystal cell. The VA type liquid crystal display device may have an alignment division mode as described, for example, in Japanese Patent Application Laid-Open No. Hei 10-123576. In these aspects, a polarizing plate using the cellulose ester film of the present invention contributes to the enlargement of viewing angle and the improvement of contrast.

(IPS Type Liquid Crystal Display Device and ECB Type Liquid Crystal Display Device)

The cellulose ester film of the present invention is particularly advantageously used as a retardation film, a support of the retardation film, or a protective film of a polarizing plate in an IPS type liquid crystal display device having an IPS mode liquid crystal cell and an ECB type liquid crystal display device having an ECB mode liquid crystal cell. When black is displayed, these modes are an aspect in which the liquid crystal materials are aligned substantially in parallel with each other, and the liquid crystal molecules are aligned in parallel with the surface of the substrate in no voltage applied state to achieve a black display. In these aspects, a polarizing plate using the cellulose ester film of the present invention contributes to the enlargement of viewing angle and the improvement of contrast.

It is preferred to have |Rth| of less than 25 nm, but it is particularly preferred that the optical film has Rth of 0 nm or less in a region of 450 nm to 650 nm, because tint changes are small.

In these aspects, it is preferred that among protective films of the polarizing plate on and below the liquid crystal cell, the polarizing plate using the cellulose ester film of the present invention is used on and below the liquid crystal cell in a protective film (a protective film on the cell side) disposed between the liquid cell and the polarizing plate. It is more preferred that an optically anisotropic layer set to have a retardation value twice or less the value of Δn·d of the liquid crystal layer is disposed on one side between the protective film of the polarizing plate and the liquid crystal cell.

(OCB Type Liquid Crystal Display Device and HAN Type Liquid Crystal Display Device)

The cellulose ester film of the present invention is also advantageously used as a support of a retardation film in an OCB type liquid crystal display device having an OCB mode liquid crystal cell or an HAN type liquid crystal display device having an HAN mode liquid crystal cell. In the retardation film used in the OCB type or the HAN type liquid crystal display devices, it is preferred that the direction in which the absolute retardation value is the lowest exists in neither an in-plane direction nor the nominal direction thereof. The optical properties of the retardation film used in the OCB type liquid crystal display device or the HAN type liquid crystal display device are also determined by optical properties of the optically anisotropic layer, optical properties of the support, and the arrangement between the optically anisotropic layer and the support. A retardation film used in the OCB type liquid crystal display device or the HAN type liquid crystal display device is described in Japanese Patent Application Laid-Open No. Hei 9-197397. There is also a description in a paper (Mori, et al., Japanese Journal of Appl. Phys., vol. 38 (1999) p. 2837).

<<Reflective Type Liquid Crystal Display Device>>

The cellulose ester film of the present invention is also advantageously used as a retardation film in reflective type liquid crystal display devices of a TN type, an STN type, a HAN type, and a GH (Guest-Host) type. These display modes have long been known. The TN type reflective liquid crystal display devices are described in Japanese Patent Application Laid-Open No. Hei 10-123478, International Publication No. WO98/48320, and Japanese Patent No. 3022477. A retardation film used in the reflective type liquid crystal display device is described in International Publication No. WO00/65384.

(Other Liquid Crystal Display Devices)

The cellulose ester film of the present invention is also advantageously used as a support of a retardation film in axially symmetric aligned microcell (ASM) type liquid crystal display devices having an ASM mode liquid crystal cell. An ASM mode liquid crystal cell is characterized in that the cell thickness is maintained by a resin spacer whose position is adjustable. Other properties are the same as those of a TN mode liquid crystal cell. With respect to the ASM mode liquid crystal cell and the ASM type liquid crystal display device, there is a description in a paper by Kume et al. (SID 98 Digest, p. 1089 (1998)).

The cellulose ester film of the present invention may be used as a retardation film or a support of the retardation film which is preferably used as an image display panel which may display 3D image displays. Specifically, a λ/4 layer may be formed on the entire surface of the cellulose ester film of the present invention or, for example, a patterned phase difference layer having different birefringence refractive index alternately in a line type may be formed. The cellulose ester film of the present invention has a smaller dimensional change to a change in humidity than that of the cellulose acylate film in the related art, and thus the optical film may be preferably used over the latter.

(Hardcoat Film, Antiglare Film and Antireflective Film)

The cellulose ester film of the present invention is applicable to a hardcoat film, an antiglare film or an antireflective film. Any one or all of a hardcoat layer, an antiglare layer, and an antireflective layer may be provided on one side or both sides of the optical film of the present invention for the purpose of improving visibility of flat panel displays, such as LCDs, PDPs, CRTs, ELs, and the like. Preferred embodiments of such applications as an antiglare film and an antireflective film are described in detail in Japan Institute of Invention and Innovation Journal of Technical Disclosure (Technical Publication No. 2001-1745, Mar. 15, 2001, published by Japan Institute of Invention and Innovation) pp 54 to 57, and the cellulose ester film of the present invention may be preferably used.

(Transparent Substrate)

Because the cellulose ester film of the present invention may be formed with an optical anisotropy close to zero, has excellent transparency and experiences a small change in retardation even though the film is maintained under a moist heat environment, the cellulose ester film may also be used as a substitute for a liquid crystal cell glass substrate of a liquid crystal display device, that is, a transparent substrate for sealing a driving liquid crystal.

The transparent substrate for sealing a liquid crystal is required to have excellent gas barrier properties, and thus a gas barrier layer may be provided on the surface of the cellulose ester film of the present invention if necessary. The form or material of the gas barrier layer is not particularly limited, but methods of vapor depositing SiO₂ or the like on at least one side of the optical film of the present invention, or providing a coat layer of a polymer having relatively high gas barrier properties, such as vinylidene chloride-based polymer or vinyl alcohol-based polymer, or stacking these inorganic and organic layers are contemplated, and the methods may be appropriately used.

For use as a transparent substrate for sealing a liquid crystal, a transparent electrode for driving a liquid crystal by application of a voltage may be provided. The transparent electrode is not particularly limited, but a transparent electrode may be provided by stacking a metal film, a metal oxide film, and the like on at least one side of the optical film of the present invention. Among them, from the viewpoint of transparency, electrical conductivity, and mechanical properties, metal oxide films are preferred, and among the metal oxide films, a thin film of indium oxide containing mainly tin oxide and zinc oxide in an amount of 2% to 15% may be preferably used. The details of these technologies are disclosed, for example, in Japanese Patent Application Laid-Open Nos. 2001-125079, 2000-227603, and the like.

### EXAMPLES

Hereinafter, characteristics of the present invention will be described in more detail with reference to Examples. The materials, amounts, ratios, operations, order of operations, and the like shown in the Examples below may appropriately be modified without departing from the spirit of the present invention. Therefore, the scope of the present invention should not be construed as being limited by specific Examples shown below.

<<Measurement Methods>>

First, measurement methods and evaluation methods of characteristics are shown below.

(Degree of Substitution)

The degree of substitution of acyl of a cellulose acylate was determined by ¹³C-NMR analysis in accordance with the methods described in Tezuka et al., Carbohydr. Res., 273 (1995), pp. 83 to 91.

(Retardation)

Five points (a central portion, edge portions (positions at 5% of each of the total width from both ends), and 2 points at the intermediate portions of the central portion and the edge portions of a film) in a width direction of the film were sampled at every 100 m in a longitudinal direction, samples having a size of 5 cm angle were cut, and an average value at each point, which was evaluated by the above-described method was calculated to obtain each of Rth and ΔRth.

(Weight Reduction Rate)

A weight reduction rate was calculated from a weight change when the film was subjected to heat treatment at 140° C. for 1 hr by using TG-DTA6200 (manufactured by SII Inc.).

<<1>> Manufacture and Evaluation of Cellulose Ester Film

The cellulose ester film of the present invention was manufactured by selecting the materials and manufacturing methods described in Tables 1 and 2 from materials and manufacturing methods shown below.

(Preparation of Cellulose Acylate Solution)

1] Cellulose acylates A and B having different degrees of substitution of cellulose acylate were used. Each cellulose acylate was dried by heating at 120° C. to make the water content to 0.5% by mass or less, and then was used in an amount of 20 parts by mass.

Cellulose Acylate A:

A powder of cellulose acetate having a degree of substitution of 2.86 was used. Of the cellulose acylate A, the viscosity average polymerization degree was 300, the degree of substitution of an acetyl group at 6-position was 0.89, the acetone extract was 7% by mass, the ratio of mass average molecular weight/number average molecular weight was 2.3, the water content was 0.2% by mass, the viscosity in 6% by mass of a dichloromethane solution was 305 mPa, the residual acetic acid content was 0.1% by mass or less, the Ca content was 65 ppm, the Mg content was 26 ppm, the Fe content was 0.8 ppm, the sulfate ion content was 18 ppm, the yellow index was 1.9, and the free acetic acid content was 47 ppm. The average particle size of the powder was 1.5 mm and the standard deviation was 0.5 mm.

Cellulose Acylate B:

A powder of cellulose acetate showing a performance identical to that of the cellulose acylate A was used, except that the degree of substitution was changed to 2.90.

2] Solvent

The following solvent A was used. Each solvent had a water content of 0.2% by mass or less.

Solvent A dichloromethane/methanol/butanol=81/18/1 (mass ratio)

3] Polyester and Other Additives

Polyester described in the following Table 1 and the following retardation controlling agent were used. The following silicon dioxide fine particles were also used in an amount of the parts by mass described below in dopes for a support surface and an air surface.

The number average molecular weight (Mn) and the ratio of components having a molecular weight of 500 or less of the polyester were measured by GPC. Low-molecular weight components having a molecular weight of 500 or less of the polyester were removed by distillation.

TABLE 1

| | Composition | | | | GPC | |
|---|---|---|---|---|---|---|
| | | | | Terminal | | Ratio of Components |
| Polyester | AA | EG | PG | Structure | Mn | having Mn of 500 or less |
| A | 50 | 50 | 0 | Ac | 1644 | 3 |
| B | 50 | 50 | 0 | Ac | 884 | 6 |
| C | 50 | 50 | 0 | Ac | 1390 | 2 |
| D | 50 | 40 | 10 | Ac | 1264 | 4 |
| E | 50 | 35 | 15 | Ac | 1505 | 4 |
| F | 50 | 40 | 10 | Ac | 884 | 6 |
| G | 50 | 35 | 15 | Ac | 884 | 6 |
| H | 50 | 50 | 0 | Ac | 1137 | 4 |
| I | 50 | 50 | 0 | OH | 884 | 6 |
| J | 50 | 50 | 0 | Ac | 1257 | 8 |
| K | 50 | 50 | 0 | Ac | 1135 | 10 |
| L | 50 | 50 | 0 | Ac | 853 | 18 |
| M | 50 | 50 | 0 | Ac | 4880 | 4 |
| N | 50 | 35 | 15 | Ac | 1263 | 8 |
| O | 50 | 35 | 15 | Ac | 2643 | 5 |
| P | 50 | 50 | 0 | Ac | 418 | 91 |
| Q | 50 | 50 | 0 | OH | 1257 | 8 |

In Table 1, AA, EG, PG and Ac represent adipic acid, ethylene glycol, 1,2-propylene glycol and acetic acid, respectively.

(Retardation Controlling Agent)

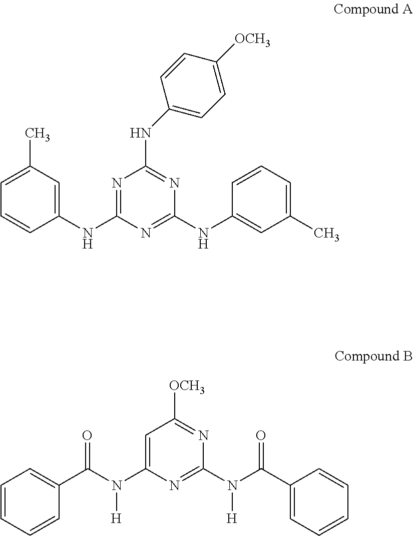

Silicon Dioxide Fine Particles (Particle Size 20 nm, Mohs Hardness about 7) (0.02 Part by Mass)

4] Dissolution

The solvent and the additives were introduced into a 400 L stainless steel dissolver tank equipped with a stirring blade and the cellulose acylate was slowly added thereto while the mixture in the tank was dispersed by stirring. After completion of the introduction, the mixture was stirred at room temperature for 2 hr, swollen for 3 hr, and again stirred to obtain a cellulose acylate solution.

For stirring, a dissolver-type eccentric stirring shaft stirring at a circumferential speed of 5 m/sec (shear stress 5×10⁴ kgf/m/sec^{2[}4.9×10⁵ N/m/sec²]) and a stirring shaft with an anchor blade was mounted on the central axis thereof, stirring at a circumferential speed of 1 m/sec (shear stress 1×10⁴ kgf/m/sec^{2[}9.8×10⁴ N/m/sec²]), were used. The swelling was carried out by stopping the high-speed stirring shaft and setting the circumferential speed of the stirring shaft having the anchor blade to 0.5 m/sec. The swollen solution from the tank was then heated to 50° C. through a jacketed pipe and then heated up to 90° C. under a pressure of 1.2 MPa to achieve complete dissolution. The heating time was 15 minutes. In this case, the filter, housing, and piping to be exposed to high temperature were made of a highly anti-corrosive Hastelloy alloy (trade mark) and jacketed with a circulating heat medium for heat insulation and heating. Subsequently, the solution was then cooled to 36° C. to obtain a cellulose acylate solution.

The dope thus obtained prior to concentration was flashed in a tank at a normal pressure at 80° C., and the evaporated solvent was recovered and separated with a condenser. The solid concentration of the dope after the flash was 23.5% by mass. The condensed solvent was returned to the recovering process so as to be reused as a solvent for the preparation process (the recovery is performed by the distillation process, dehydration process, and the like). The dope was defoamed in the flash tank by rotating the shaft equipped with an anchor blade on the central shaft at a circumferential speed of 0.5 msec to stir the dope. The temperature of the dope in the tank was 25° C., and the average retention time in the tank was 50 min.

5] Filtration

Next, the dope was first passed through a sintered woven metal filter having a nominal pore diameter of 10 μm and then through a sintered woven metal filter having a nominal pore diameter of 10 μm in the same manner. The dope was stored in a 2,000 L stainless steel stock tank while the temperature of the dope after the filtration was adjusted to 36° C.

(Manufacture of Film)

1] Casting Process

Subsequently, the dope in the stock tank was transferred. The casting die was equipped with a feed block which had a width of 2.1 m and was adjusted for co-casting, and used a device for allowing films to be stacked to have a structure of three layers on both sides thereof in addition to the main stream. In the following explanation, a layer to be formed from the main stream refers to an intermediate layer, a layer on the side of a support surface refers to a support surface, and the opposite surface refers to an air surface. The solution sending flow channels of the dope used three flow channels for an intermediate layer, a support surface, and an air surface, and each solid concentration was appropriately controlled by adding a solvent to decrease the concentration or by adding a solution having a high solid concentration to increase the concentration. Dopes for an intermediate layer, a support surface, and an air surface, as described above, were not different from each other except that silicon dioxide fine particles were used in dopes for a support surface and an air surface, and the same cellulose acylate, polyester, and other additives shown in Table 2 were used.

The casting was performed by controlling the dope flow rate at the die exit point to have a casting width of 2000 mm. In order to control the temperature of the dope to 36° C., a jacket was provided on the casting die to control the temperature of a heat transmitting medium at the inlet to 36° C. The die, the feed block and the pipe were all maintained at 36° C. during the work process.

2) Casting Die

A material for the die is a two-phase stainless steel having a mixed composition of an austenite phase and a ferrite phase and has a thermal expansion coefficient of 2×10⁻⁶ (° C.⁻¹), and a material having corrosion resistance approximately equivalent to that of SUS316 when evaluated by a forced corrosion test in an electrolytic aqueous solution was used. As a lip tip of the casting die, a lip tip on which a WC coating is formed by a flame spraying method was used. A mixed solvent (dichloromethane/methanol/butanol (83/15/2 parts by mass)) which is a solvent for solubilizing the dope is supplied to air-liquid interfaces of the bead end and the slit at 0.5 ml/min on one side.

3) Metal Support

As the support, a mirror surface stainless steel support which is a drum having a width of 2.1 m and a diameter of 3 m was used for the dope extruded from the die. Nickel casting and hard chromium plating were performed on the surface thereof. The drum was polished to a surface roughness of 0.01 μm or less, no pin holes of 50 um or more existed, and a support with pinholes of 10 um to 50 um at 1 ea/m² or less and pin holes of 10 μm or less at 2 ea/m² was used. In this case, the temperature of the drum was set to −5° C., and the number of rotations was set to have a circumferential speed of 5 m/min of the drum. When the surface of the drum was contaminated by the casting, cleaning was appropriately performed.

4) Casting Drying

Subsequently, the dope which was cast, cooled, and gelled on the drum disposed on the space set at 15° C. was peeled off as a gelled film (web) at a time point when the dope was rotated on the drum at 320°. In this case, the peel-off speed was set to 106% with respect to the support speed.

5) Tenter Conveying/Drying Process Conditions

The peeled off web was conveyed into a drying zone by a tenter having pin clips while being fixed at both edges thereof, and dried with a drying wind.

6) Post Drying Process Conditions

The polymer film obtained by the above-described method was further dried in a roller conveying zone. A material of the roller was aluminum or carbon steel, and a surface of the roller was plated with hard chromium. The surface shape of the roller was flat or matted by blasting.

7) Post-Treatment and Winding Conditions

The polymer film after being dried was cooled to 30° C. or less, and trimmed at both edges. The film was trimmed by installing every two devices for slitting each of both edge portions of the film in each of the film (two slitting devices on one side) and slitting the edge portions of the film. The film was further knurled at both edges thereof. The knurling was performed by embossing the film on one side thereof. In this manner, a film having a width of 1400 mm was obtained as a final product and wound by a winding machine.

The winding chamber was kept at a room temperature of 25° C. and a humidity of 60%. The diameter of a winding core was set to 169 mm. The total length of winding was 2600 m.

(Surface Shape Evaluation of Film)

The surface shape of each cellulose acylate film manufactured was evaluated in accordance with the following standards under an environment of observation from reflected light. The evaluation results are shown in the following Table 2. In the following evaluation standard, “deformation failure” refers to circular unevenness deformation having a diameter of 2 mm or more, generated on the surface of the film.

A: No deformation failure within a range having a film length of 5,000 m

B: Two or less deformation failures within a range having a film length of 5,000 m

C: More than two deformation failures within a range having a film length of 5,000 m

<<2>> Manufacture and Evaluation of Polarizing Plate

(Manufacture of Polarizing Plate)

1] Saponification of Film

Each of the cellulose acylate films prepared in Examples and Comparative Examples and Fuji Tack TD60UL (manufactured by Fuji Film Corporation) were immersed in a 4.5 mol/L sodium hydroxide aqueous solution (saponification liquid) which was temperature-controlled at 37° C. for 1 min, and then the film was washed with water, immersed in a 0.05 mol/L sulfuric acid aqueous solution for 30 sec, and again passed through a washing bath. And then, water removal was performed three times with an air knife and dried in a drying zone at 70° C. for a retention time of 15 sec to manufacture a saponified film.

2] Manufacture of Polarizing Plate

A 20 μm thick polarizer was prepared by imparting the difference in circumferential speed to two pairs of nip rolls and stretching the rolls in a longitudinal direction in accordance with Example 1 of Japanese Patent Application Laid-Open No. 2001-141926.

3] Lamination

The thus-obtained polarizer was interposed in between one sheet selected from the saponified cellulose acylate films and the Fuji Tack TD60UL, and then the films were laminated roll-to-roll via a 3% polyvinyl alcohol (manufactured by Kuraray Co., Ltd., PVA-117H) aqueous solution as an adhesion bond such that the axis of polarization and the longitudinal direction of the cellulose acylate films are orthogonal to each other, thereby making a polarizing plate.

3] Mounting Evaluation on Liquid Crystal Display Device

(Mounting on IPS Type Liquid Crystal Display Devices)

Polarizing plates having liquid crystal cells inserted therebetween were peeled off from a commercially available liquid crystal display television set (slim type 42 type liquid crystal display TV set of IPS mode), and the polarizing plates manufactured above was re-laminated to the liquid crystal cells with an adhesive such that the cellulose acylate film described in Table 2 is disposed on the liquid crystal cell side. Display characteristics of the re-assembled liquid crystal display television set were identified to confirm the luminance intensity and tint from the front surface and the inclined surface, and as a result, characteristics equivalent to those before the polarizing plate was peeled off were observed.

When the characteristics were observed from the front surface of the device, the luminance intensity nonuniformity was observed in black display, and thus evaluation was performed in accordance with the following standards (initial evaluation).

The evaluation results are shown in Table 2.

(Levels of Optical Nonuniformity from Front Direction)

When the characteristics were observed from the front surface of the device, the luminance intensity nonuniformity was observed in black display, and thus evaluation was performed in accordance with the following standards.

A: Nonuniformity was not visible under an environment of an illumination intensity of 100 1×

B: Nonuniformity was rarely visible under an environment of an illumination intensity of 100 1×

C: Dim nonuniformity was visible under an environment of an illumination intensity of 100 1×

D: Apparent nonuniformity was visible under an environment of an illumination intensity of 100 1×

E: Apparent nonuniformity was visible under an environment of an illumination intensity of 300 1×

The sample was kept under an environment of 40° C. and 80% RH for 20 days, and then transferred to an environment of 25° C. and 60% RH. Illumination was continuously maintained in a black display state. The sample was observed with bare eyes after 48 hrs to evaluate optical nonuniformity when observed from the front direction and the inclined surface direction (forced evaluation). The evaluation results are shown in Table 2.

(Levels of Optical Nonuniformity from Front Direction)

When the characteristics were observed from the front surface of the device, the luminance intensity nonuniformity was observed in black display, and thus evaluation was performed in accordance with the following standards.

A: Nonuniformity was not visible under an environment of an illumination intensity of 100 1×

B: Nonuniformity was rarely visible under an environment of an illumination intensity of 100 1×

C: Dim nonuniformity was visible under an environment of an illumination intensity of 100 1×

D: Apparent nonuniformity was visible under an environment of an illumination intensity of 100 1×

E: Apparent nonuniformity was visible under an environment of an illumination intensity of 300 1×

(Levels of Optical Nonuniformity from Inclined Surface Direction)

The luminance intensity nonuniformity was observed in black display at an azimuth direction of 45° and a polar angle direction of 70°, and then evaluation was performed in accordance with the following standards.

A: Nonuniformity was not visible under an environment of an illumination intensity of 100 1×

B: Nonuniformity was rarely visible under an environment of an illumination intensity of 100 1×

C: Dim nonuniformity was visible under an environment of an illumination intensity of 100 1×

D: Apparent nonuniformity was visible under an environment of an illumination intensity of 100 1×

E: Apparent nonuniformity was visible under an environment of an illumination intensity of 300 1×

TABLE 2

| | Cotton | | | | | |
|---|---|---|---|---|---|---|
| | (Cellulose ester) | | Polyester | | | |
| | | Degree of | | amount | Other additives | |
| Cellulose | Kind | substitution of acetyl | Kind | wt | Kind | Amount |
| ester film | — | — | — | % based on the cotton | — | wt % based on the cotton |
| 1 | A | 2.86 | A | 50 | Compound A | 1 |
| 2 | A | 2.86 | B | 50 | Compound A | 1 |
| 3 | A | 2.86 | C | 50 | Compound A | 1 |
| 4 | A | 2.86 | D | 50 | Compound A | 1 |
| 5 | A | 2.86 | E | 50 | Compound A | 1 |
| 6 | A | 2.86 | F | 50 | Compound A | 1 |
| 7 | A | 2.86 | G | 50 | Compound A | 1 |
| 8 | A | 2.86 | H | 50 | Compound A | 1 |
| 9 | A | 2.86 | B | 45 | Compound A | 1 |
| 10 | A | 2.86 | B | 40 | Compound A | 1 |
| 11 | A | 2.86 | I | 50 | Compound B | 1 |
| 12 | A | 2.86 | B | 38.5 | Compound B | 1.5 |
| 13 | B | 2.90 | B | 38.5 | Compound B | 1..5 |
| 14 | B | 2.90 | B | 38.5 | Compound B | 3.5 |
| 15 | A | 2.86 | J | 50 | Compound A | 1 |
| 16 | A | 2.86 | K | 50 | Compound A | 1 |
| 17 | A | 2.86 | L | 50 | Compound A | 1 |
| 18 | A | 2.86 | M | 50 | Compound A | 1 |
| 19 | A | 2.86 | N | 50 | Compound A | 1 |
| 20 | A | 2.86 | O | 50 | Compound A | 1 |
| 21 | A | 2.86 | P | 50 | Compound A | 1 |
| 22 | A | 2.86 | Q | 50 | Compound A | 1 |
| 23 | A | 2.86 | K | 45 | Compound A | 1 |
| 24 | A | 2.86 | K | 40 | Compound A | 1 |
| 25 | A | 2.86 | K | 35 | Compound A | 1 |
| 26 | A | 2.86 | B | 38.5 | — | — |

| | Film characteristics | | | | | | | | |
|---|---|---|---|---|---|---|---|---|---|
| | | | | Weight | | Mounting evaluation | | | |
| | Film | | ΔRth | reduction | Film | Initial | Forced | Forced | |
| Cellulose | thickness | Rth | (10% RH-80% RH) | rate | surface | front | front | inclined | |
| ester film | [μ] | [nm] | [nm] | [%] | shape | surface | surface | surface | Remark |
| 1 | 50 | −6 | 6.7 | 0.12 | A | A | A | A | Example |
| 2 | 50 | −9 | 4.1 | 0.00 | A | A | A | A | Example |
| 3 | 50 | −9 | 6.7 | 0.12 | A | A | A | A | Example |
| 4 | 50 | −9 | 6.6 | 0.13 | A | A | A | A | Example |
| 5 | 50 | −7 | 8.0 | 0.12 | A | A | B | B | Example |
| 6 | 50 | −9 | 4.1 | 0.00 | A | A | A | A | Example |
| 7 | 50 | −9 | 4.1 | 0.00 | A | A | A | A | Example |
| 8 | 50 | −9 | 5.4 | 0.06 | A | A | A | A | Example |
| 9 | 50 | −8 | 5.6 | 0.00 | A | A | A | A | Example |
| 10 | 50 | −7 | 7.7 | 0.00 | A | A | A | A | Example |
| 11 | 50 | −9 | 5.6 | 0.00 | A | A | A | A | Example |
| 12 | 50 | −8 | 5.6 | 0.00 | A | A | A | A | Example |
| 13 | 50 | −15 | 4.5 | 0.00 | A | A | A | A | Example |
| 14 | 50 | −8 | 2.8 | 0.00 | A | A | A | A | Example |
| 15 | 50 | −10 | 6.7 | 0.30 | C | A | A | A | Comparative |
| 16 | 50 | −11 | 5.5 | 0.29 | C | A | A | A | Comparative |
| 17 | 50 | −12 | 2.2 | 0.57 | C | A | A | A | Comparative |
| 18 | 50 | 5 | 11.6 | 0.00 | A | A | D | D | Comparative |
| 19 | 50 | −8 | 7.0 | 0.30 | C | A | A | A | Comparative |
| 20 | 50 | 5 | 10.1 | 0.20 | A | A | D | D | Comparative |
| 21 | 50 | −20 | −2.8 | 2.63 | C | A | A | A | Comparative |
| 22 | 50 | −10 | 8.1 | 0.12 | A | A | C | C | Comparative |
| 23 | 50 | −4 | 8.4 | 0.15 | A | A | C | C | Comparative |
| 24 | 50 | −3 | 10.5 | 0.10 | A | A | D | D | Comparative |
| 25 | 50 | −2 | 13.3 | 0.10 | A | A | D | D | Comparative |
| 26 | 50 | −8 | 8.4 | 0.00 | A | A | C | C | Comparative |

As shown in Table 2, the cellulose ester film of the present invention had excellent film shape, and a liquid crystal display device into which the film used as a polarizing plate protective film was inserted could prevent the occurrence of optical nonuniformity on the display surface.

What is claimed is:

1. A cellulose ester film comprising: a cellulose ester and at least one polyester, wherein a number average molecular weight of the polyester is 2,500 or less and a ratio of components having a molecular weight of 500 or less in the polyester is less than 8%.

2. The cellulose ester film of claim 1, wherein the polyester is a polycondensed ester of an aliphatic dicarboxylic acid and an aliphatic diol.

3. The cellulose ester film of claim 2, wherein both terminals of the polyester are an ester derivative of an aliphatic monocarboxylic acid.

4. The cellulose ester film of claim 2, wherein the aliphatic diol has an average carbon number of 2 to 3.

5. The cellulose ester film of claim 2, wherein the aliphatic dicarboxylic acid has an average carbon number of 4 to 6.

6. The cellulose ester film of claim 1, wherein an amount of the polyester is 30% by mass or more based on the cellulose ester.

7. The cellulose ester film of claim 1, further comprising at least one nitrogen-containing aromatic compound.

8. The cellulose ester film of claim 1, wherein the cellulose ester film has an in-plane retardation Re of 0 to 5 nm and a retardation Rth in a thickness direction of −20 to 10 nm, at 25° C. and 60% RH, and
a difference between a retardation Rth (10% RH) in the thickness direction at 25° C. and 10% RH and a retardation Rth (80% RH) in the thickness direction at 25° C. and 80% RH satisfies the following equation:
Rth(10% RH)−Rth(80% RH)<8 nm.

9. The cellulose ester film of claim 1, wherein a weight reduction rate of a film when kept at 140° C. for 1 hr is less than 0.25%.

10. A polarizing plate comprising a cellulose ester film of claim 1.

11. A liquid crystal display device comprising a polarizing plate of claim 10.
